(19) United States
(12) Patent Application Publication
(10) Pub. No.: US 2014/0119343 A1
(43) Pub. Date: May 1, 2014

(54) DUAL RECEIVE PAGING MONITORING PROCEDURE

(71) Applicant: QUALCOMM INCORPORATED, San Diego, CA (US)

(72) Inventors: Tom Chin, San Diego, CA (US); Guangming Shi, San Diego, CA (US); Kuo-Chun Lee, San Diego, CA (US)

(73) Assignee: QUALCOMM Incorporated, San Diego, CA (US)

(21) Appl. No.: 13/664,680

(22) Filed: Oct. 31, 2012

(51) Int. Cl. H04W 72/04

(52) U.S. Cl. 370/335; 370/337

(57) ABSTRACT

A user equipment capable of communicating on multiple radio access technologies (RATs) may receive conflicting paging occasions for each RAT. That is, the paging occasions may occur at sufficiently overlapping times such that a user equipment may not dedicate all its receive resources to each paging occasion. In such instances, a user equipment may divide receive resources among the RATs to receive pages even in the face of paging occasion conflicts.

### BACKGROUND

1. Field

Aspects of the present disclosure relate generally to wireless communication systems, and more particularly to dual receive paging monitoring procedures.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes determining when an upcoming time period of a portion of a paging occasion of a first radio access technology (RAT) conflicts with a time period of a portion of a paging occasion of a second RAT. The method may also include allocating a plurality of receive resources to one of the RATs for each portion of the paging occasion when there is no conflict. The method may also include allocating a receive resource to each RAT for each portion of the paging occasion when there is a conflict.

According to another aspect of the present disclosure, an apparatus for wireless communication includes means for means for determining when an upcoming time period of a portion of a paging occasion of a first RAT conflicts with a time period of a portion of a paging occasion of a second RAT. The apparatus may also include means for allocating a plurality of receive resources to one of the RATs for each portion of the paging occasion when there is no conflict. The apparatus may also include means for means for allocating a receive resource to each RAT for each portion of the paging occasion when there is a conflict.

According to one aspect of the present disclosure, a computer program product for wireless communication in a wireless network includes a computer readable medium having non-transitory program code recorded thereon. The program code includes program code to determine when an upcoming time period of a portion of a paging occasion of a first RAT conflicts with a time period of a portion of a paging occasion of a second RAT. The program code also includes program code to allocate a plurality of receive resources to one of the RATs for each portion of the paging occasion when there is no conflict. The program code also includes program code to allocate a receive resource to each RAT for each portion of the paging occasion when there is a conflict.

According to one aspect of the present disclosure, an apparatus for wireless communication includes a memory and a processor(s) coupled to the memory. The processor(s) is configured to determine when an upcoming time period of a portion of a paging occasion of a first RAT conflicts with a time period of a portion of a paging occasion of a second RAT. The processor(s) is further configured to allocate a plurality of receive resources to one of the RATs for each portion of the paging occasion when there is no conflict. The processor(s) is further configured to allocate a receive resource to each RAT for each portion of the paging occasion when there is a conflict.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates a network coverage area according to aspects of the present disclosure.

FIG. 5 illustrates a discontinuous reception cycle for Time Division-Synchronous Code Division Multiple Access (TD-SCDMA) including a paging block periodicity, a structure of a TD-SCDMA paging indicator channel, and a structure of a TD-SCDMA paging channel.

FIG. 6 is a block diagram illustrating an example of a Global System for Mobile Communications (GSM) frame structure.

FIG. 7 is a block diagram illustrating a GSM control channel structure of the GSM frame structure of FIG. 6.

FIG. 8 illustrates an exemplary timeline for dual receive resources for receiving a paging message communicated during a first GSM discontinuous receive cycle and a first TD-SCDMA discontinuous receive cycle.

FIG. 9 illustrates a paging implementation for resolving a paging conflict between a common control channel (CCCH) burst period and a paging indicator channel (PICH) time slot.

FIG. 10 illustrates a paging implementation 1000 for resolving paging conflicts between CCCH burst periods and paging channel (PCH) time slots.

FIG. 11A illustrates a difference in time between a start time of a TD-SCDMA time slot and an end time of a GSM burst period relative to a frequency tuning time.

FIG. 11B illustrates a difference in time between an end time of a TD-SCDMA time slot and a start time of a GSM burst period relative to a frequency tuning time.

FIG. 12 illustrates an exemplary timeline for dual receive resources for receiving a PCH and a CCCH according to an interleaved schedule.

FIG. 13 illustrates an exemplary timeline for dual receive resources for receiving a PCH and a CCCH according to an interleaved schedule.

FIG. 14 is a block diagram illustrating a dual receive paging monitoring method according to one aspect of the present disclosure.

FIG. 15 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

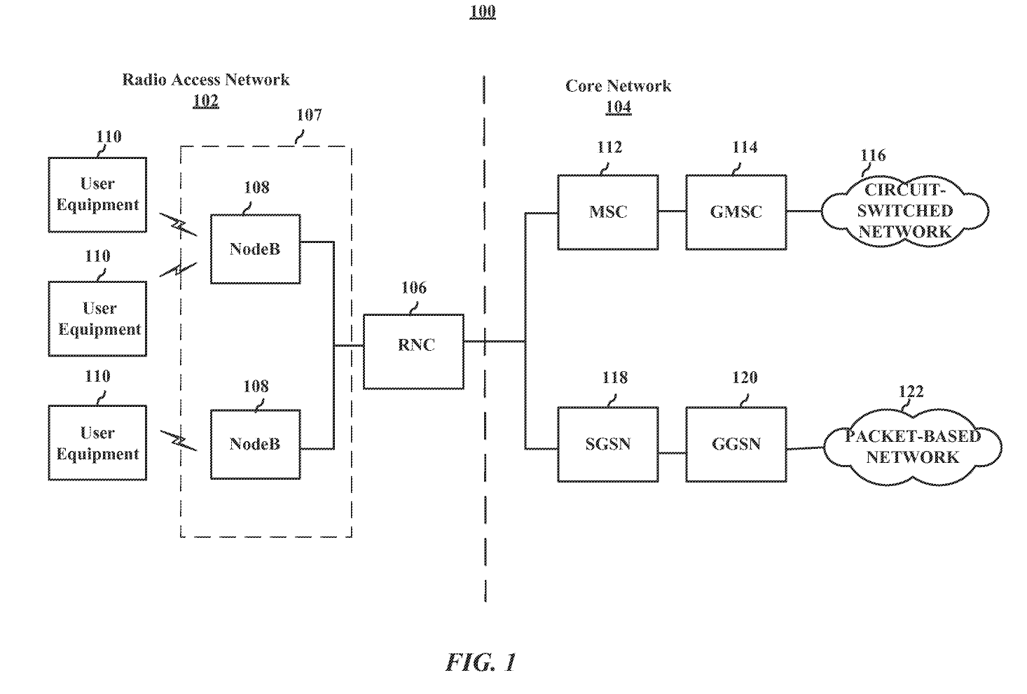

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

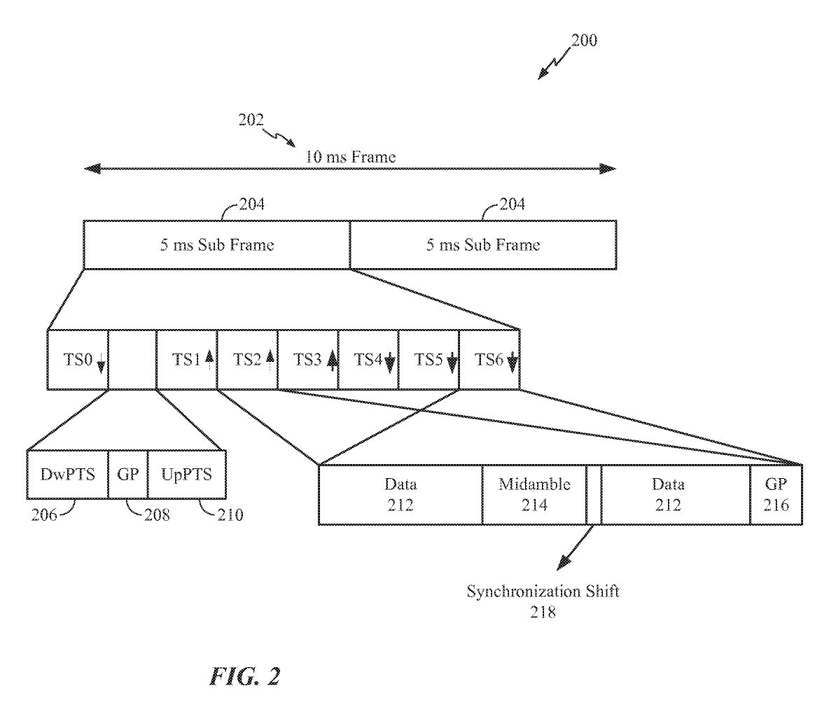

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

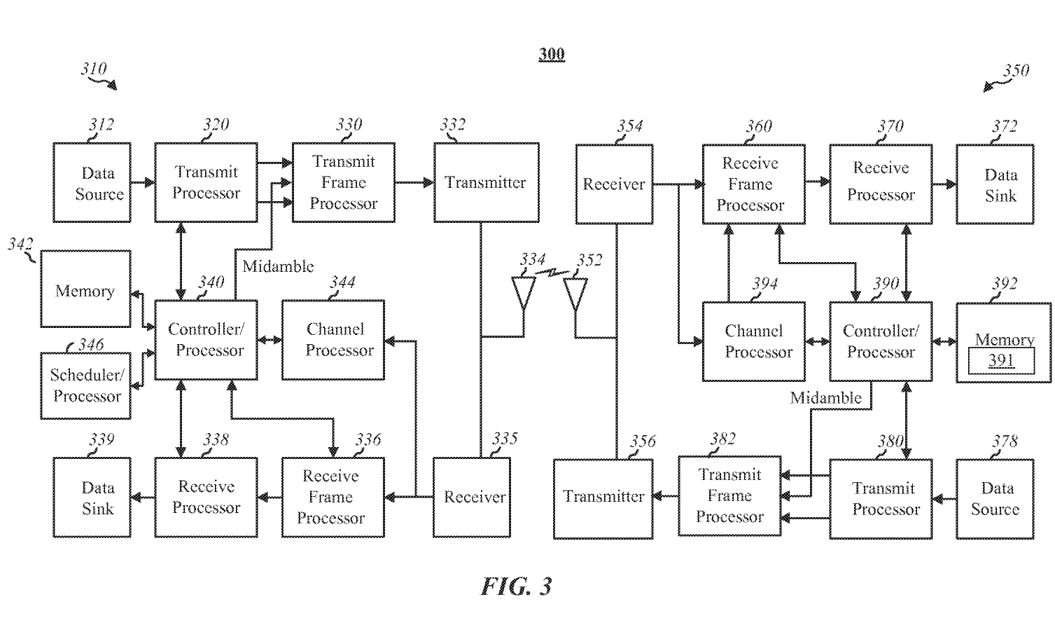

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store an dual receive paging monitoring module 391 which, when executed by the controller/processor 390, configures the UE 350 for inter-RAT/inter-frequency measurements. A scheduler/processor 346 at the node B 310 may be used to allocate resources to the UEs and schedule downlink and/or uplink transmissions for the UEs.

Certain UEs may be capable of communicating on multiple radio access technologies (RATs). Such UEs may be referred to as multimode UEs. For example, a multimode UE may be capable of communications on a Universal Terrestrial Radio Access (UTRA) frequency division duplexed (FDD) network such as a Wideband-Code Division Multiple Access (W-CDMA) network, a UTRA time division duplexed (TDD) network such as a Time Division-Synchronous Code Division Multiple Access (TD-SCDMA) network, Global System for Mobile Communications (GSM) and/or a Long Term Evolution (LTE) network.

### Dual Receive Paging Monitoring Procedure

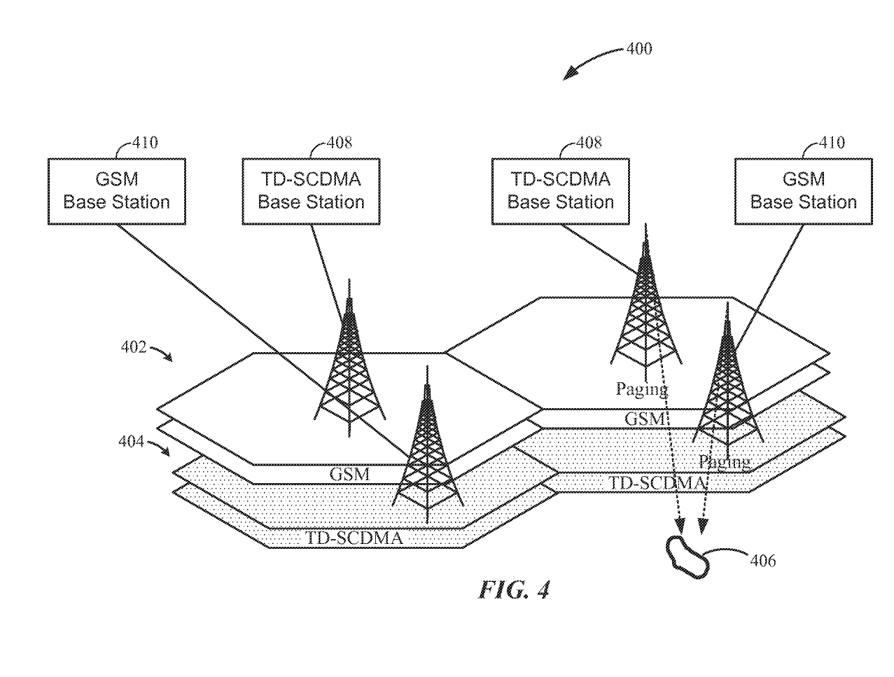

Some networks, such as a newly deployed network, may cover only a portion of a geographical area. Other networks, such as older more established networks, may provide more coverage. In deployment, the newly deployed network may be overlaid with an older more established network. FIG. 4 illustrates such an example, showing a geographic area covered by both a TD-SCDMA network and a GSM network. A geographical area 400 may include both GSM network coverage 402 and TD-SCDMA network coverage 404. A UE 406 in an idle state with both radio access technologies (RATs) (i.e., the TD-SCDMA network and GSM network) may periodically tune to a TD-SCDMA base station 408 and/or a GSM base station 410 to monitor or listen to a paging message. The paging messages may be communicated according to discontinuous reception (DRX) communications. For example, the paging messages may be communicated according to a GSM DRX cycle and/or a TD-SCDMA DRX cycle.

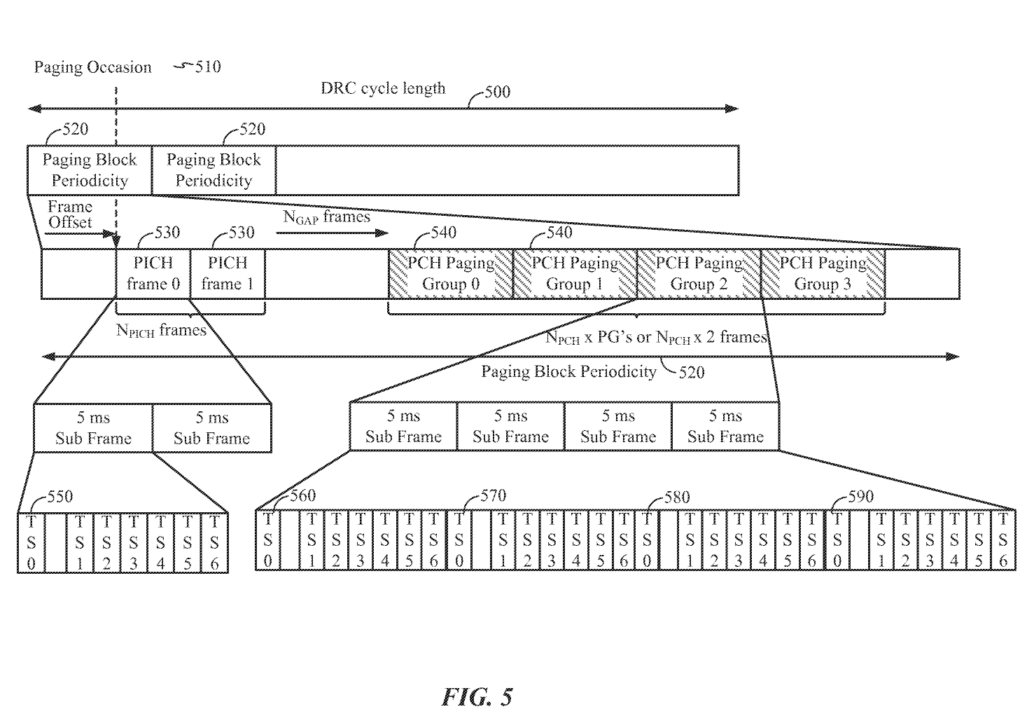

FIG. 5 illustrates a DRX cycle 500 for TD-SCDMA including a paging block periodicity 520. The paging block periodicity 520 is a number of frames between two paging blocks. Each paging block period includes a number of frames for a TD-SCDMA paging indicator channel (PICH) 530 and a number of frames for a TD-SCDMA paging channel (PCH) 540. There are four paging channel frames (called PCH Paging Group 0-3) in the paging block periodicity 520. There is a PICH 530 for N_{PICH} frames and a PCH 540 with N_{PCH}*2 frames per paging block periodicity. There are N_{GAP} frames from the end of the PICH 530 to the beginning of the PCH 540. The UE may be assigned to one of the N_{PICH} frames in a PICH block and one of the N_{PCH} paging groups (PGs).

Each PICH frame includes two 5 ms subframes. Each subframe is structured similarly to subframe 204 discussed above in reference to FIG. 2. Similarly, each PCH paging group includes two 5 ms subframes. Each subframe is structured similarly to subframe 204 discussed above in reference to FIG. 2. The UE may decode one TD-SCDMA time slot, e.g., time slot 550, for PICH and four TD-SCDMA time slots, e.g., time slots 560, 570, 580 and 590, for PCH 540 when the PICH 530 indicates a potential paging message. The UE may be assigned to monitor different PICH 530 and PCH 540 based on the International Mobile System Identity (IMSI) of UE, or other UE identifier.

In TD-SCDMA, a UE in idle mode DRX operation may listen to certain recurrent paging blocks with a PICH 530. Each UE may listen to the PICH 530 starting with an associated paging occasion 510 and decode the PCH 540 when the PICH 530 indicates that a potential page for the UE was sent in the PCH 540. A length of the DRX cycle 500 in the idle mode may be may vary and may include a number of different lengths including 80 milliseconds (ms), 160 ms, etc.

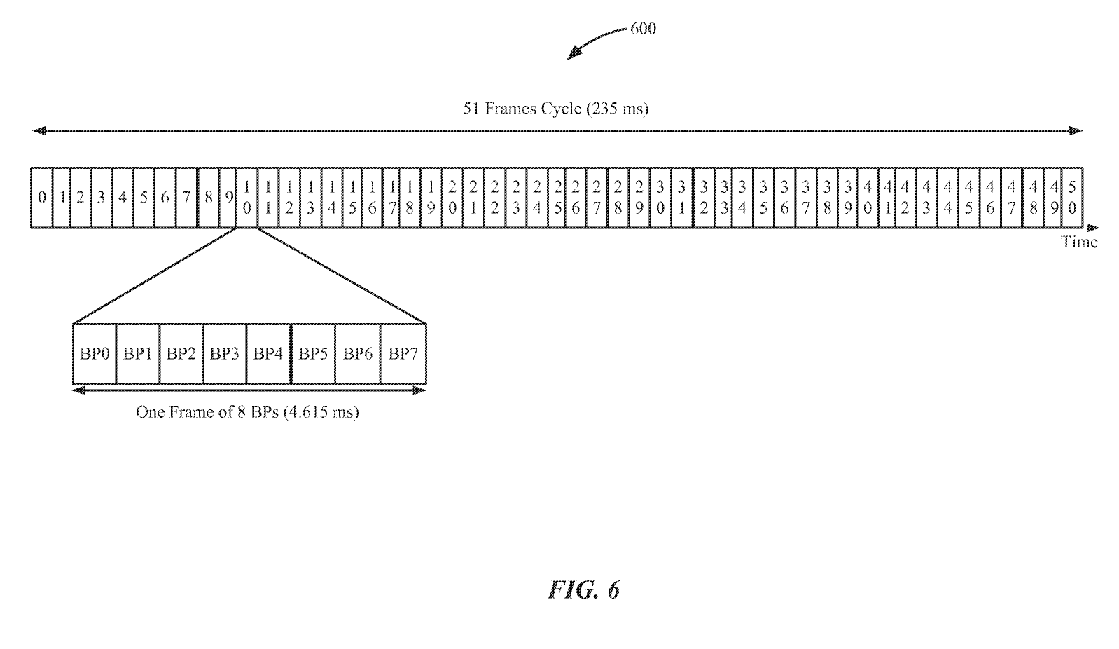

FIG. 6 is a block diagram illustrating an example of a GSM frame structure 600. The GSM frame structure 600 includes fifty-one frame cycles for a total duration of 235 ms. Each frame of the GSM frame structure 600 may have a frame length of 4.615 ms and may include eight burst periods, BP0-BP7.

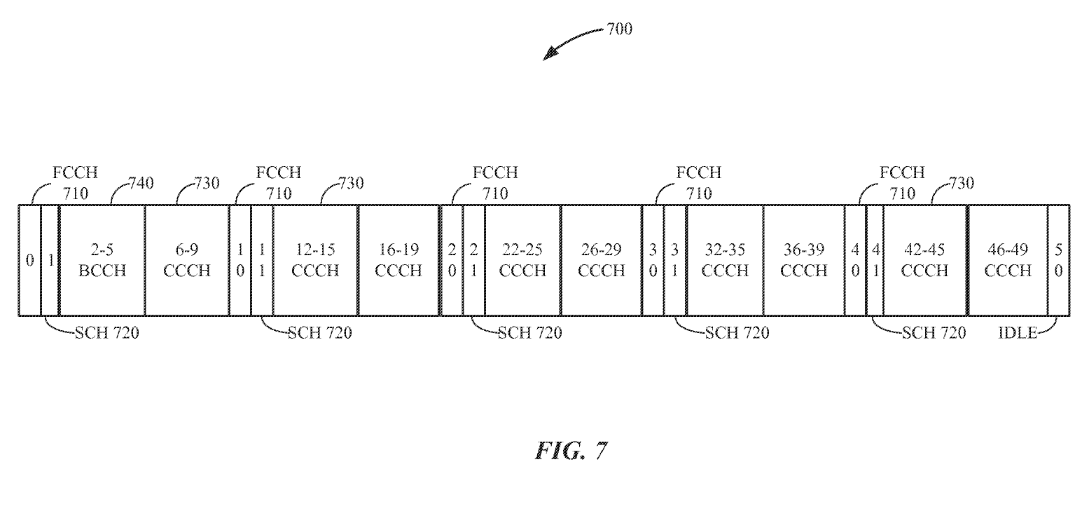

FIG. 7 is a block diagram illustrating a GSM control channel structure 700 of the GSM frame structure 600 of FIG. 6. Control channels of the GSM control channel structure 700 include repetitions of a Frequency Correction Channel (FCCH) 710, a Synchronization Channel (SCH) 720, and a Common Control Channel (CCCH) 730. The GSM control channel structure 700 may also include a broadcast control channel (BCCH) 740. The FCCH 710 may be a pilot of a 200 kilohertz (KHz) frequency channel. The SCH 720 can carry a base station identity code (BSIC) information. The FCCH 710 is transmitted in a burst period of frames 0, 10, 20, 30, and 40. The SCH 720 is transmitted in the burst period of frames 1, 11, 21, 31, and 41 of the 51-frame cycle. A burst period is 15/26 ms and a frame is 120/26 ms, which corresponds to a 235 ms time length for a 51-frame cycle. Each 10 or 11-frame interval can last for 46.15 or 50.77 ms. The BCCH 730 is carried in the next four frames following the first FCCH 710 and the first SCH 720. The BCCH 730 carries system messages that identify a page indicator or beacon, and the beacon's configuration and access parameters. The next four frames following the BCCH 730 is the first CCCH 740 which also includes 4 frames. The first four frames of the CCCH 740 are followed by another FCCH 710/SCH 720 pair in the following frame and this process then repeats with 2 CCCH 740 sets (8 frames) and a FCCH 710/SCH 720 pair for the remainder of the 51-multiframe.

To monitor the paging messages, a UE such as a GSM UE periodically wakes up to listen to paging messages on one CCCH block per GSM DRX cycle. Paging messages directed to the UE are transmitted in paging blocks belonging to the UE's paging group. A next paging block for a particular paging group may appear after an interval of 2 to 9 multiframes, as indicated by a value of a system parameter such as BS_PA_MFRMS which is broadcast on the BCCH 730. The BS_PA_MFRMS message indicates number of multiframes between two transmissions of the paging messages to UEs of the same paging group. Receive resources of the UE in idle mode may receive a paging block approximately every 470.8 ms to 2.1 seconds (s). A UE may decode 4 burst periods, separated by 4.67 ms, per DRX cycle.

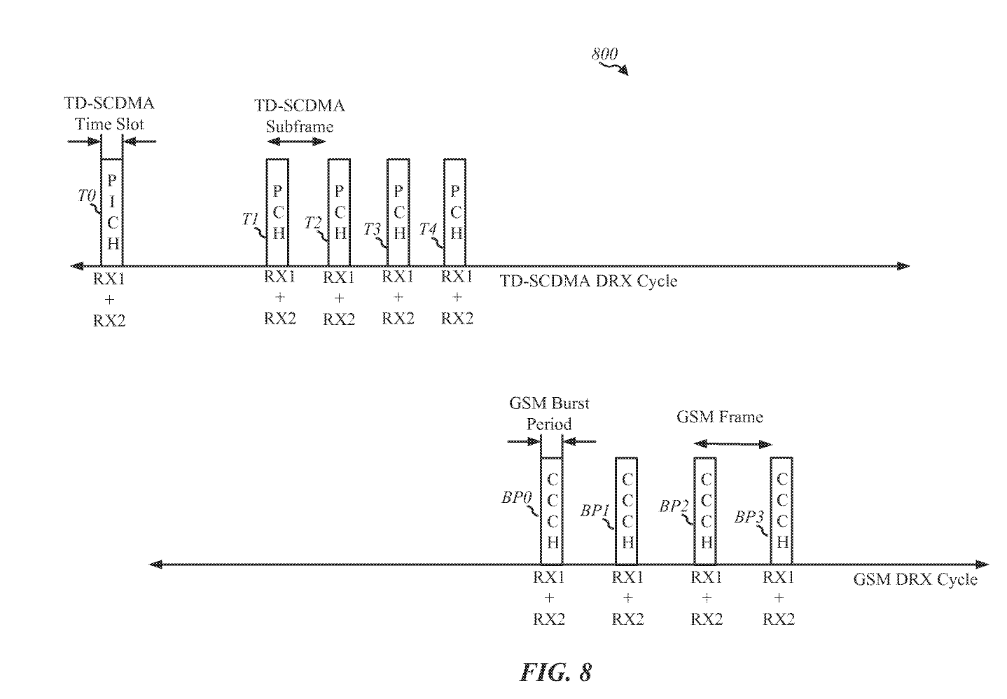

FIG. 8 illustrates an exemplary timeline 800 for dual receive resources for receiving a paging message communicated during a first GSM DRX cycle and a first TD-SCDMA DRX cycle. The paging message from the TD-SCDMA network may include the PICH and the PCH. A time slot T0 may be allocated to carry the PICH and time slots T1-T4 may be allocated to carry 4 PCHs. Each PCH time slot may occupy a portion of a TD-SCDMA subframe. In some configurations, each time slot may have a duration of 0.5 ms and two time slots may be separated by a time period of 5 ms. Similarly, in some configurations, each burst period may have a duration of 0.5 ms and two burst periods may be separated by a time period of 5 ms. The paging message from the GSM network may include the CCCH. Burst periods BP0-BP3 are allocated to carry four CCCHs. Each CCCH burst period may occupy a portion of a GSM frame.

A UE may include two or more receive resources such as receive radio frequency chains RX1 and RX2, to monitor for paging messages. The two or more resources may include two configurable antennas, which may be operable simultaneously. For example, the UE 350 may use both the receive resources RX1 and RX2 to monitor a paging message from the GSM network or the UE 350 may use both the receive resources RX1 and RX2 to monitor a paging message from the TD-SCDMA network. In the illustration of FIG. 8, the UE 350 listens to one network at a time with both of the receive resources RX1 and RX2 (which is possible due to no overlap in the paging occasion, i.e., time interval to listen to a paging message).

However, monitoring one network (i.e., TD-SCDMA network or the GSM network) at a time with both receive resources RX1 and RX2 allocated for both networks may introduce a delay to the system for monitoring paging. Further, when a time period for paging occasions for the TD-SCDMA and GSM networks overlap, this leads to a paging conflict, and the UE may only choose one network from which to listen to the paging message. The paging conflict may occur during the first GSM DRX cycle and the first TD-SCDMA DRX cycle. The paging conflict may be associated with portions of the time period of the paging occasion such as time slots of the TD-SCDMA frame and burst periods of the GSM frame. For example, a time slot for the TD-SCDMA frame may overlap with a burst period for GSM frame causing the paging conflict.

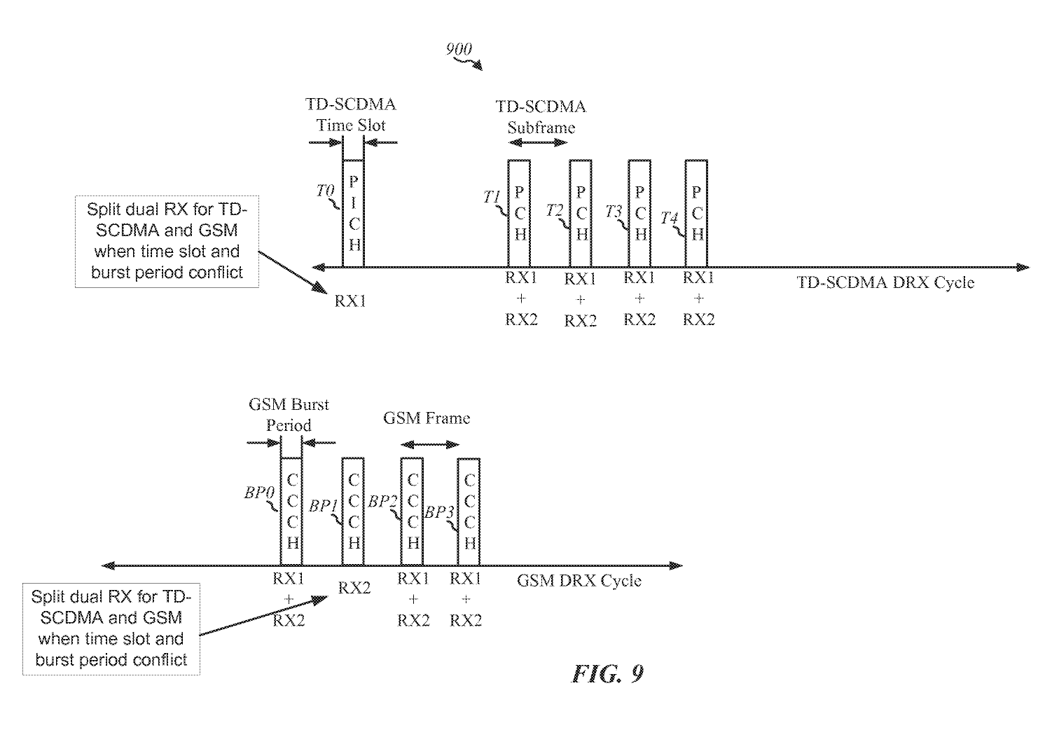

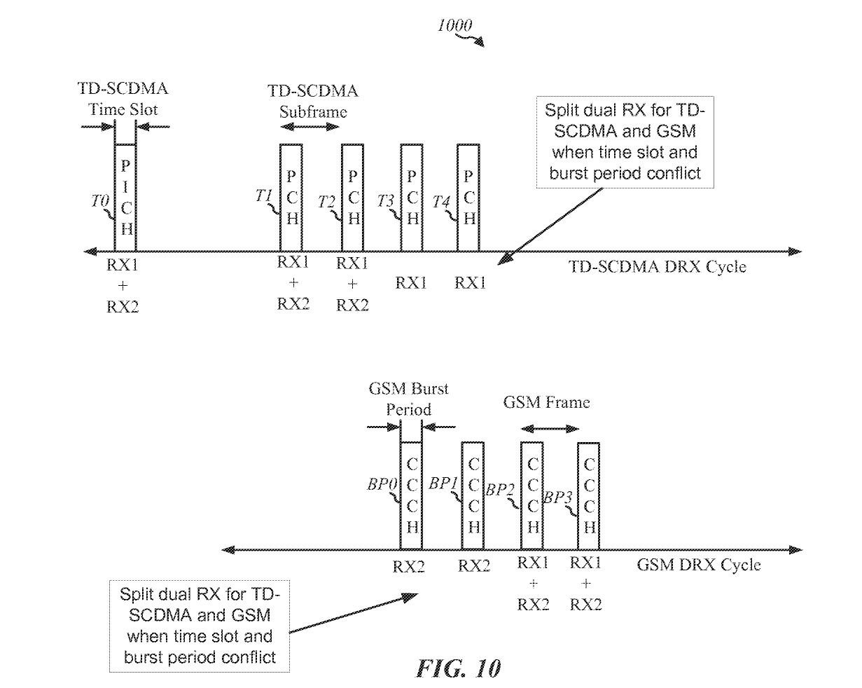

Aspects of the present disclosure include an implementation to simultaneously monitor paging messages of both the TD-SCDMA network and the GSM network while avoiding paging conflicts and avoiding missing paging messages. When paging messages of different RATs overlap causing a paging conflict (such as a TD-SCDMA time slot carrying the PICH/PCH and a GSM burst period carrying the CCCH) the receive resources may be split such that a receive resource is allocated to each of individual paging messages (such as the PICH time slot/PCH time slot and the CCCH burst period) as illustrated in FIGS. 9 and 10 according to some aspects of the present disclosure.

FIG. 9 illustrates a paging implementation 900 for resolving a paging conflict between a CCCH burst period BP1 and a PICH time slot T0. The paging conflict caused by an overlap in time between time slot T0 carrying a PICH and burst period BP1 carrying a CCCH is identified. In one aspect of the present disclosure, the receive resources RX1 and RX2 of the UE are split between the burst period BP1 and the time slot T0 to avoid the paging conflict by monitoring the paging messages simultaneously using the different receive resources. For example, the receive resource RX1 may be used to monitor the paging message for the TD-SCDMA network at the time slot T0 and the receive resource RX2 may be used to monitor the paging message for the GSM network at the burst period BP1.

FIG. 10 illustrates a paging implementation 1000 for resolving a paging conflict between CCCH burst periods BP0, BP1 and PCH time slots T3, T4. A paging conflict is caused by an overlap in time between time slots T3 or T4 carrying the PCH and burst period BP0 or BP1 carrying the CCCH. Similar to the implementation of FIG. 9, to resolve the paging conflict, receive resources RX1 and RX2 of the UE may be split between the burst period BP0 or BP1 and the time slot T3 or T4 while monitoring the paging messages simultaneously. For example, the receive resource RX1 may be used to monitor the paging message for the TD-SCDMA network at the time slot T3 or T4 and the receive resource RX2 may be used to monitor the paging message for the GSM network at burst period BP0 or BP1.

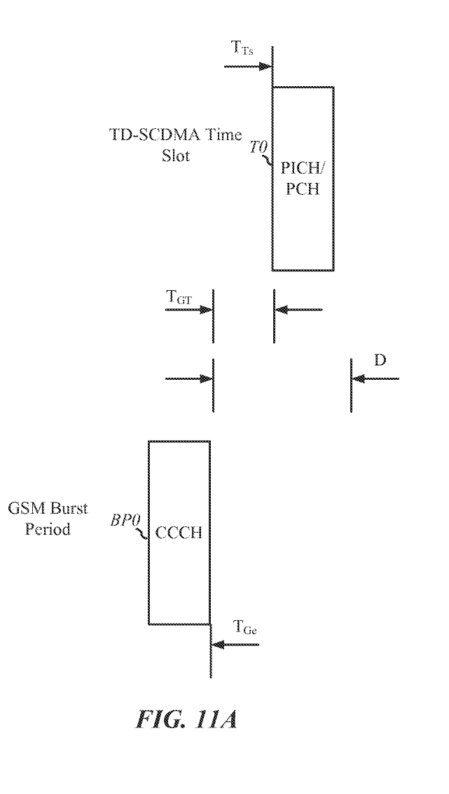

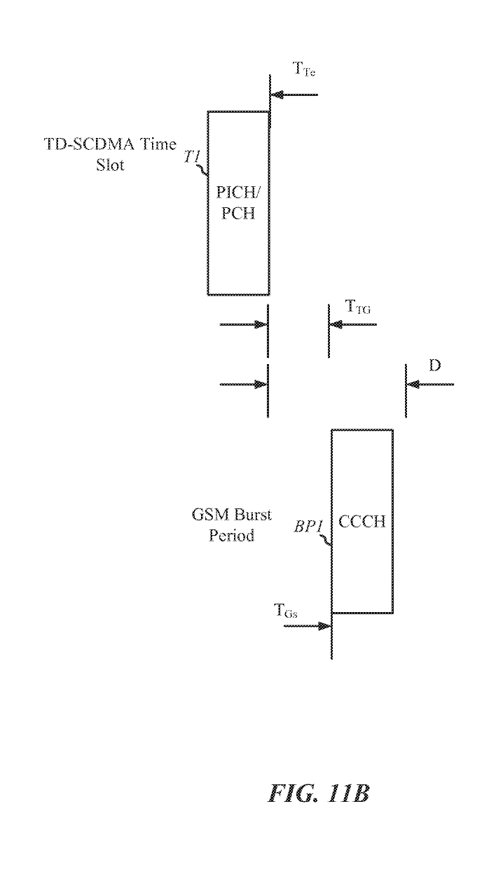

Some aspect of the disclosure account for a frequency tuning time or tuning delay D due to switching a receive resource from one RAT to another when monitoring paging messages. As noted, the receive resources RX1 and RX2 may be split between PICH time slot/PCH time slot and CCCH burst period when a paging conflict is identified. In one aspect of the present disclosure, a determination of the paging conflict may be based at least in part on the tuning delay D. In a first implementation of this aspect, a paging conflict exists when a difference in time, T_{GT}, between a start time, T_{Ts}, of a TD-SCDMA time slot T0 and an end time, T_{Ge}, of a GSM burst period BP0 is not greater than the tuning delay D as illustrated in FIG. 11A. The difference in time T_{GT} is too short to tune one receive resource from the GSM network to the TD-SCDMA network. As a result, the paging messages are subject to a paging conflict. When a paging conflict is determined under these conditions, a receive resource of the UE is allocated to each of the networks to avoid the paging conflict as described. In a second implementation of this aspect, a paging conflict exists when a difference in time, T_{TG}, between an end time T_{Te}, of a TD-SCDMA time slot T1 and a start time T_{Gs} of a GSM burst period BP1 is not greater than the tuning delay D as illustrated in FIG. 11B. Similar to the first implementation, because the difference in time T_{TG} is too short to tune one receive resource from the TD-SCDMA network to the GSM network, the paging messages are subject to a paging conflict. As a result, a receive resource of the UE is allocated to each of the networks to avoid the paging conflict.

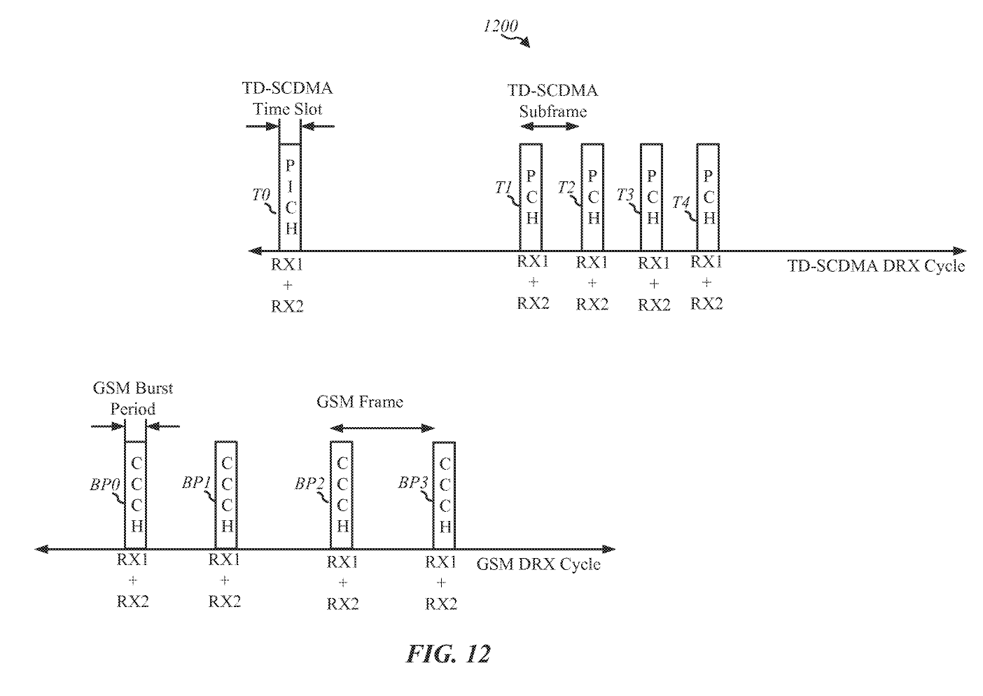

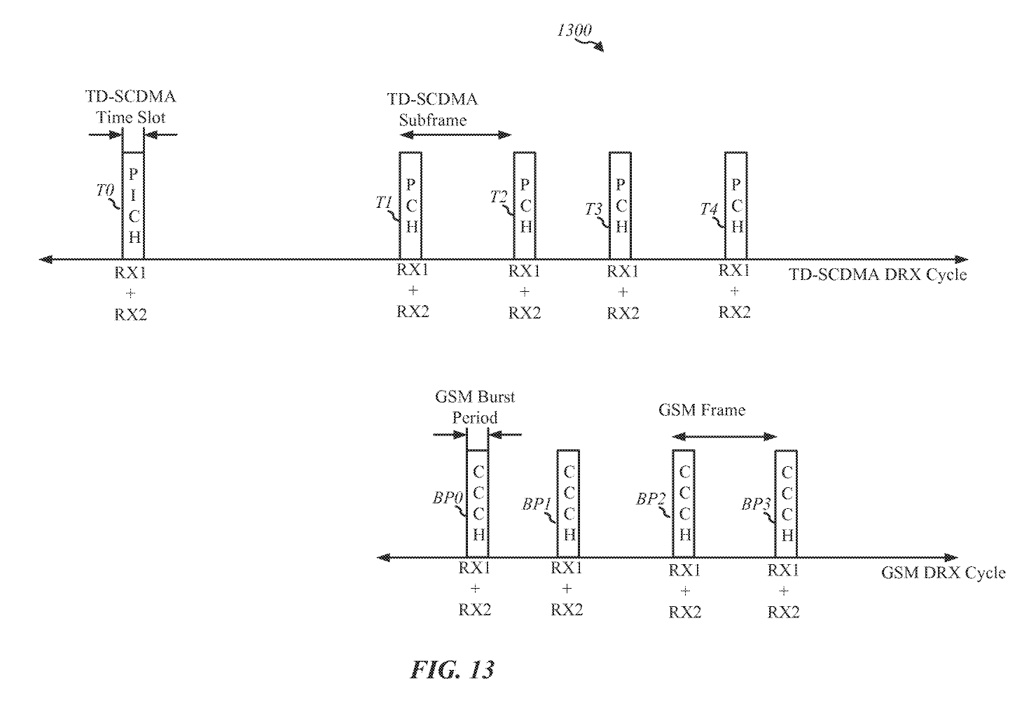

In one aspect of the disclosure, the paging messages from the TD-SCDMA network and the GSM network may be received based on an interleaved schedule to avoid paging conflicts. Two or more receive resources may be allocated to carry the PICH/PCH and/or CCCH according to the interleaved schedule as illustrated in FIGS. 12 and 13 according to some aspects of the present disclosure.

FIG. 12 illustrates an example timeline 1200 for dual receive resources for receiving the PICH and the CCCH according to an interleaved schedule. In this illustration, the time slots, T0-T4 are scheduled such that the time slots are interleaved between the burst periods, BP0-BP3. For example, a time slot T0 carrying the PICH is interleaved between burst periods BP1 and BP2 carrying CCCHs to avoid an overlap of time between the time slot T0 and the burst periods BP1 and BP2. By interleaving the PICH time slot T0 between the CCCH burst periods BP1 and BP2 a paging conflict is avoided and as a result each of the time slot T0 and the burst periods BP1 and BP2 can be allocated all of the receive resources RX1 and RX2 of the UE.

In one aspect of the disclosure, the time slot T0 and burst period BP1 are interleaved such that the time difference between a start time of the time slot T0 and an end time of the burst period BP1 is greater than the tuning delay D to account for the tuning delay, such as the delay illustrated in FIGS. 11A. Further, the time slot T0 and burst period BP2 may be interleaved such that the time difference between an end time of the time slot T0 and a start time of the burst period BP2 is greater than the tuning delay D to account for the tuning delay D, such as the delay illustrated in FIGS. 11B. In these cases, the time of and between paging messages may be adjusted. Thus, interleaving the time slots and burst periods while accounting for the tuning delay D may further reduce the occurrence of paging conflicts.

FIG. 13 illustrates an exemplary timeline 1300 for dual receive resources for receiving the PCH and the CCCH according to an interleaved schedule. Similar to the interleaved scheduling of the PICH time slot T0 and the CCCH burst periods BP0-BP3 illustrated with respect to FIG. 12, time slots T1-T4 carrying the PCH are also interleaved between the CCCH burst periods BP0-BP3 to avoid paging conflicts. Similar to the interleaved schedule illustrated with respect to FIG. 12, the interleaved schedule of the time slots T1-T4 and burst periods BP0-BP3 illustrated in FIG. 13 may account for the tuning delay D to further reduce the occurrence of paging conflicts. As a result of the interleaved schedule, both receive resources RX1 and RX2 may be allocated for each of the time slots T1-T4 and burst periods BP0-BP3 to improve the probability of successfully decoding a paging message.

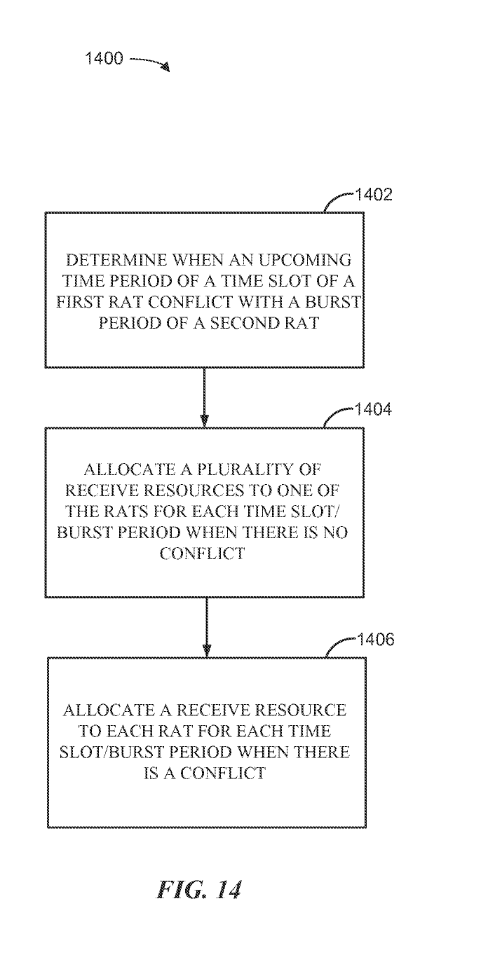

FIG. 14 shows a wireless communication method 1400 according to one aspect of the disclosure. A UE may determine when an upcoming time period of a portion of a paging occasion of a first radio access technology (RAT) conflicts with a time period of a portion of a paging occasion of a second RAT, as shown in block 1402. The UE may allocate a plurality of receive resources to one of the RATs for each portion of the paging occasion when there is no conflict, as shown in block 1404. The UE may allocate a receive resource to each RAT for each portion of the paging occasion when there is a conflict, as shown in block 1406.

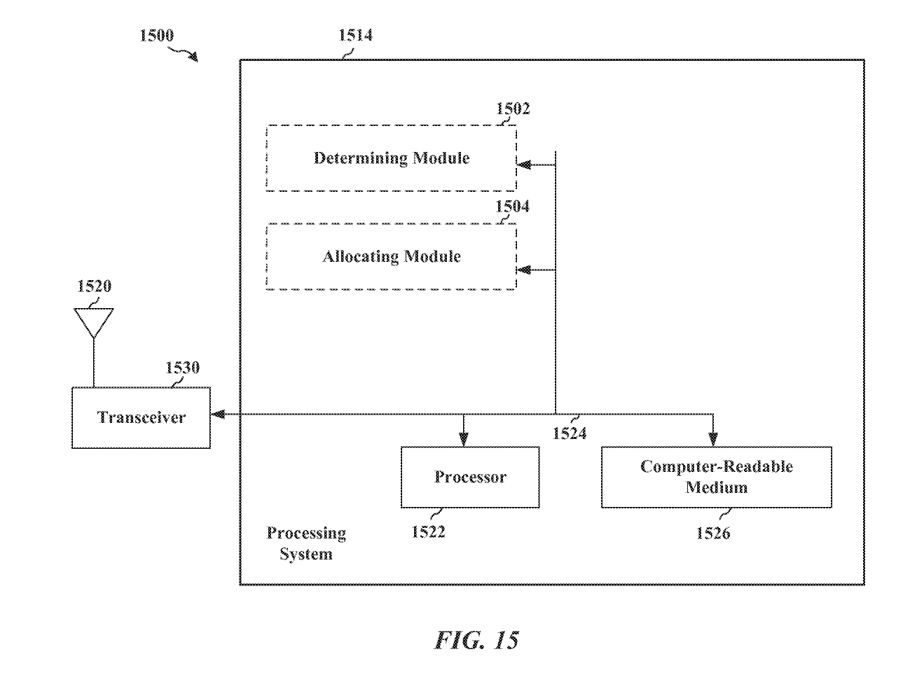

FIG. 15 is a diagram illustrating an example of a hardware implementation for an apparatus 1500 employing a dual receive paging monitoring system 1514. The dual receive paging monitoring system 1514 may be implemented with a bus architecture, represented generally by the bus 1524. The bus 1524 may include any number of interconnecting buses and bridges depending on the specific application of the dual receive paging monitoring system 1514 and the overall design constraints. The bus 1524 links together various circuits including one or more processors and/or hardware modules, represented by the processor 1522 the modules 1502, 1504 and the computer-readable medium 1526. The bus 1524 may also link various other circuits such as timing sources, peripherals, voltage regulators, and power management circuits, which are well known in the art, and therefore, will not be described any further.

The apparatus includes the dual receive paging monitoring system 1514 coupled to a transceiver 1530. The transceiver 1530 is coupled to one or more antennas 1520. The transceiver 1530 enables communicating with various other apparatus over a transmission medium. The dual receive paging monitoring system 1514 includes a processor 1522 coupled to a computer-readable medium 1526. The processor 1522 is responsible for general processing, including the execution of software stored on the computer-readable medium 1526. The software, when executed by the processor 1522, causes the dual receive paging monitoring system 1514 to perform the various functions described for any particular apparatus. The computer-readable medium 1526 may also be used for storing data that is manipulated by the processor 1522 when executing software.

The dual receive paging monitoring system 1514 includes a determining module 1502 for determining when an upcoming time period of a portion of a paging occasion of a first RAT conflict with a time period of a portion of a paging occasion of a second RAT. The dual receive paging monitoring system 1514 includes an allocating module 1504 for allocating a plurality of receive resources to one of the RATs for each portion of the paging occasion when there is no conflict. The allocating module 1504 also allocates a receive resource to each RAT for each portion of the paging occasion when there is a conflict. The modules may be software modules running in the processor 1522, resident/stored in the computer-readable medium 1526, one or more hardware modules coupled to the processor 1522, or some combination thereof. The dual receive paging monitoring system 1514 may be a component of the UE 350 and may include the memory 392, and/or the controller/processor 390.

In one configuration, an apparatus such as a UE is configured for wireless communication including means for determining and means for allocating. In one aspect, the above means may be the channel processor 394, the receive frame processor 360, the receive processor 370, the transmit frame processor 382, the transmit processor 380, the controller/processor 390, the memory 392, the dual receive paging monitoring module 391, determining module 1502, allocating module 1504 and/or the dual receive paging monitoring system 1514 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA and GSM systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining when an upcoming time period of a portion of a paging occasion of a first radio access technology (RAT) conflicts with a time period of a portion of a paging occasion of a second RAT;
allocating a plurality of receive resources to one of the RATs for each portion of the paging occasion when there is no conflict; and
allocating a receive resource to each RAT for each portion of the paging occasion when there is a conflict.

2. The method of claim 1, in which the first RAT is time division synchronous code division multiple access (TD-SCDMA) and the portion of the paging occasion of the first RAT is a time slot.

3. The method of claim 1, in which the second RAT is Global System for Mobile Communications (GSM) and the portion of the paging occasion of the second RAT is a burst period.

4. The method of claim 1, in which communications for the first RAT and the second RAT are discontinuous reception communications.

5. The method of claim 1, in which the determining is based on a frequency tuning time of a receive resource.

6. The method of claim 1, further comprising scheduling the portion of the paging occasion of the first RAT and the portion of the paging occasion of the second RAT such that the portion of the paging occasion of the first RAT is interleaved with respect to the portion of the paging occasion of the second RAT.

7. An apparatus for wireless communication, comprising:
means for determining when an upcoming time period of a portion of a paging occasion of a first radio access technology (RAT) conflicts with a time period of a portion of a paging occasion of a second RAT;
means for allocating a plurality of receive resources to one of the RATs for each portion of the paging occasion when there is no conflict; and
means for allocating a receive resource to each RAT for each portion of the paging occasion when there is a conflict.

8. The apparatus of claim 7, in which the first RAT is time division synchronous code division multiple access (TD-SCDMA) and the portion of the paging occasion of the first RAT is a time slot.

9. The apparatus of claim 7, in which the second RAT is Global System for Mobile Communications (GSM) and the portion of the paging occasion of the second RAT is a burst period.

10. The apparatus of claim 7, in which communications for the first RAT and the second RAT are discontinuous reception communications.

11. The apparatus of claim 7, in which the determining means further comprises means for determining based on a frequency tuning time of a receive resource.

12. The apparatus of claim 7, further comprising means for scheduling the portion of the paging occasion of the first RAT and the portion of the paging occasion of the second RAT such that the portion of the paging occasion of the first RAT is interleaved with respect to the portion of the paging occasion of the second RAT.

13. An apparatus for wireless communication, comprising:
a memory; and
at least one processor coupled to the memory and configured:
to determine when an upcoming time period of a portion of a paging occasion of a first radio access technology (RAT) conflicts with a time period of a portion of a paging occasion of a second RAT;
to allocate a plurality of receive resources to one of the RATs for each portion of the paging occasion when there is no conflict; and
to allocate a receive resource to each RAT for each portion of the paging occasion when there is a conflict.

14. The apparatus of claim 13, in which the first RAT is time division synchronous code division multiple access (TD-SCDMA) and the portion of the paging occasion of the first RAT is a time slot.

15. The apparatus of claim 13, in which the second RAT is Global System for Mobile Communications (GSM) and the portion of the paging occasion of the second RAT is a burst period.

16. The apparatus of claim 13, in which communications for the first RAT and the second RAT are discontinuous reception communications.

17. The apparatus of claim 13, in which the at least one processor is further configured to determine based on a frequency tuning time of a receive resource.

18. The apparatus of claim 13, in which the at least one processor is further configured to schedule the portion of the paging occasion of the first RAT and the portion of the paging occasion of the second RAT such that the portion of the paging occasion of the first RAT is interleaved with respect to the portion of the paging occasion of the second RAT.

19. A computer program product for wireless communications in a wireless network, comprising:
a computer-readable medium having non-transitory program code recorded thereon, the program code comprising:
program code to determine when an upcoming time period of a portion of a paging occasion of a first radio access technology (RAT) conflicts with a time period of a portion of a paging occasion of a second RAT;
program code to allocate a plurality of receive resources to one of the RATs for each portion of the paging occasion when there is no conflict; and
program code to allocate a receive resource to each RAT for each portion of the paging occasion when there is a conflict.

20. The computer program product of claim 19, in which the program code further comprises program code to schedule the portion of the paging occasion of the first RAT and the portion of the paging occasion of the second RAT such that the portion of the paging occasion of the first RAT is interleaved with respect to the portion of the paging occasion of the second RAT.
